(19) United States
(12) Patent Application Publication
(10) Pub. No.: US 2021/0268609 A1
(43) Pub. Date: Sep. 2, 2021

(54) PROCESSING APPARATUS

(71) Applicant: HONDA MOTOR CO., LTD., Tokyo (JP)

(72) Inventors: Yuichi HIRATA, Tochigi (JP); Takanori SATO, Tochigi (JP); Yuya JIN, Tochigi (JP)

(21) Appl. No.: 17/182,243

(22) Filed: Feb. 23, 2021

(30) Foreign Application Priority Data
Feb. 27, 2020 (JP) 2020-031337

(51) Int. Cl. B23K 26/70; B23K 26/38; B23K 26/08; G02B 6/44

(52) U.S. Cl. CPC B23K 26/702; B23K 26/38; B23K 26/082; G02B 6/4478; B23K 26/0838

(57) ABSTRACT

A laser processing apparatus 1 includes a laser head 31, a flexible cable 6 connecting a laser oscillator and the laser head 31 to each other, a conveyance apparatus 2 that conveys a workpiece W, a head drive mechanism 5 that moves the laser head 31 to a processing position, and a cable support mechanism 7 that moves the cable 6 in association with movement of the laser head 31. The cable support mechanism 7 includes a first holder 61 holding the cable 6, a first spring balancer 711 connected to the first holder 61 through a first wire 712, and a second spring balancer 721 connected to the first holder 61 through a second wire 722. The spring balancers 711, 721 are fixed to a support frame 8, and as viewed in plane, are arranged in a line along a width direction X perpendicular to a conveyance direction Y.

This application is based on and claims the benefit of priority from Japanese Patent Application Mo. 2020-031337, filed on 27 Feb. 2020, the content of which is incorporated herein by reference.

### BACKGROUND OF THE INVENTION

### Field of the Invention

The present invention relates to a processing apparatus. More specifically, the present invention relates to a processing apparatus that moves a processing tool connected to a supply source through a cable to a processing position to process a workpiece.

### Related Art

Typically, a laser processing apparatus has been proposed, which is configured such that a laser head that emits laser-light is moved in a plane above a plate member sent out by a conveyance apparatus to cut the plate member into a blank in a desired shape. A cable as a bundle of an optical fiber, a sensor signal line, etc. is connected to the laser head. This cable is dragged in association with movement of the laser head, and for this reason, needs to be held at a proper position by a cable holding mechanism as described in Japanese Unexamined Patent Application, Publication No. 2010-214437, for example.

In the cable holding mechanism described in Japanese Unexamined Patent Application, Publication No. 2010-214437, the laser head is moved in all directions by an articulated robot, and the cable extending from the laser head is hung by a spring balancer provided above the articulated robot. According to this cable holding mechanism, limitations due to the cable on operation and posture control of the laser head can be reduced.
Patent Document 1: Japanese Unexamined Patent Application, Publication No. 2010-214437

### SUMMARY OF THE INVENTION

However, in the cable holding mechanism described in Japanese Unexamined Patent Application, Publication Mo. 2010-214437, the spring balancer is slidable along a guide rail. Thus, when the laser head is moved, the cable and the spring balancer move together due to inertia in some cases. However, when the spring balancer is moved, the cable and the laser head might also swing, and therefore, the accuracy of processing by the laser head might be degraded.

Particularly in recent years, for improving cycle time, the plate member might be conveyed by the conveyance apparatus while the moving plate member is being cut using the laser head. However, in this case, the laser head moves intensely along a conveyance direction, and for this reason, degradation of the processing accuracy due to swinging of the cable as described above is noticeable.

The present invention is intended to provide a processing apparatus configured so that swinging of a processing tool and a cable extending from the processing tool can be reduced.

(1) The processing apparatus (e.g., a later-described laser processing apparatus 1) according to the present invention includes a processing tool (e.g., a laser irradiation apparatus 3 and a laser head 31 described later) that processes a workpiece (e.g., a later-described workpiece W), a flexible cable (e.g., a later-described cable 6) connecting a supply source and the processing tool to each other, a conveyance apparatus (e.g., a later-described conveyance apparatus 2) that conveys the workpiece along a conveyance direction (e.g., a later-described conveyance direction Y) on a conveyance path (e.g., a later-described belt B), a tool movement mechanism (e.g., a later-described head drive mechanism 5) that moves the processing tool to a processing position, and a cable support mechanism (e.g., a later-described cable support mechanism 7) that supports the cable and moves the cable in association with movement of the processing tool. The cable support mechanism includes a first holder (e.g., a later-described first holder 61) holding part of the cable, a first spring balancer (e.g., a later-described first spring balancer 711) connected to the first holder through a first wire (e.g., a later-described first wire 712), and a second spring balancer (e.g., a later-described second spring balancer 721) connected to the first holder through a second wire (e.g., a later-described second wire 722). The first; and second spring balancers are fixed above the conveyance path, and as viewed in plane, are arranged along a width direction (e.g., a later-described width direction X) perpendicular to the conveyance direction.

(2) In this case, the cable support mechanism preferably includes a pair of first outlet-side rollers (e.g., later-described first outlet-side rollers 713a, 713b) provided to sandwich the first wire, a pair of first holder-side rollers (e.g., later-described first holder-side rollers 714a, 714b) provided to sandwich a first holder side of the first wire with respect to the first outlet-side rollers and provided rotatably about an axis perpendicular to a rotation axis of the first outlet-side rollers, a pair of second outlet-side rollers (e.g., later-described second outlet-side rollers 723a, 723b) provided to sandwich the second wire and a pair of second holder-side rollers (e.g., later-described second holder-side rollers 724a, 724b) provided to sandwich a first holder side of the second wire with respect to the second outlet-side rollers and provided rotatable about an axis perpendicular to a rotation axis of the second outlet-side rollers. Outer peripheral surfaces of the first and second outlet-side rollers are preferably in a recessed shape as viewed in section. The size of each outer peripheral surface of the pairs of first and second holder-side rollers is preferably longer than the size of each outer peripheral surface of the pairs of first and second outlet-side rollers.

(3) In this case, on one side with respect to the center of a processing area of the processing tool in the width direction as viewed along the conveyance direction, the first spring balancer is preferably fixed and inclined such that the first holder-side rollers are closer to the center in the width direction than a first wire outlet of the first spring balancer. On the other side with respect to the center of the processing area in the width direction as viewed along the conveyance direction, the second spring balancer is preferably fixed and inclined such that the second holder-side rollers are closer to the center in the width direction than a second wire outlet of the second spring balancer.

(4) In this case, the cable support mechanism preferably includes a second holder (e.g., a later-described second holder 62) holding a supply source side of the cable with respect to the first holder and a third spring balancer (e.g., a later-described third spring balancer 731) connected to the second holder through a third wire (e.g., a later-described third wire 732). The third spring balancer is preferably fixed to a frame body (e.g., a later-described support frame 8) provided above the conveyance path, and as viewed in plane, is preferably arranged substantially at the center in the width direction above the conveyance path.

(5) In this case, the first and second spring balancers are, as viewed in plane, preferably arranged at the center of the processing area of the processing tool in the conveyance direction, and the third spring balancer is, as viewed in plane, preferably arranged on an upstream side of the first and second spring balancers in the conveyance direction.

(1) In the processing apparatus according to the present invention, part of the cable connecting the processing tool and the supply source to each other is held by the first holder, and the first holder is supported by the first spring balancer and the second spring balancer. With this configuration, a load on the tool movement mechanism when the processing tool is moved by the tool movement mechanism can be reduced. In the present invention, the two spring balancers are fixed above the conveyance path, and therefore, movement of the two spring balancers in association with movement of the processing tool can be prevented. Movement of the two spring balancers is prevented as described above, and therefore, swinging of the cable and the processing tool due to movement of the processing tool can be reduced. Thus, the accuracy of processing by the processing tool can be improved. In the present invention, these first and second spring balancers are, as viewed in plane, arranged in a line along the width direction perpendicular to the conveyance direction. With this configuration, the amount of movement of the cable and the amounts of expansion/contraction of the wires of the two spring balancers when the processing tool is moved along the conveyance direction and the width direction can be decreased. Thus, swinging of the processing tool can be further reduced, and therefore, the accuracy of processing by the processing tool can be further improved.

(2) In the processing apparatus according to the present invention, the first wire drawn out of the first wire outlet of the first spring balancer is sandwiched by the first outlet-side rollers and the first holder-side rollers and the second wire drawn out of the second wire outlet of the second spring balancer is sandwiched by the second outlet-side rollers and the second holder-side rollers. In the present invention the outer peripheral surfaces of the first and second outlet-side rollers are in the recessed shape as viewed in the section, and the size of each outer peripheral surface of the pairs of first and second holder-side rollers is longer than the size of each outer peripheral surface of the pairs of first and second outlet-side rollers. In the present invention the wires drawn out of the first and second wire outlets by the first and second outlet-side rollers and the first and second holder-side rollers are supported while being rolled. Thus, the wires can be bent such that the cable moves to a proper position with respect to the processing tool moving along the conveyance direction and the width direction while friction in the first and second wire outlets is reduced.

(3) As viewed along the conveyance direction in the processing apparatus according to the present invention, on one side with respect to the center of the processing area of the processing tool in the width direction, the first holder-side rollers are fixed and inclined to be closer to the center in the width direction than the first wire outlet of the first spring balancer. On the other side with respect to the center of the processing area in the width direction the second holder-side rollers are fixed and inclined to be closer to the center in the width direction than the second wire outlet of the second spring balancer. With this configuration, the drawing angles of the wires of the first and second spring balancers when the processing tool is moved along the conveyance direction and the width direction can be decreased as much as possible, and therefore, swinging of the cable and the processing tool can be further reduced.

(4) In the processing apparatus according to the present invention, the supply source side of the cable with respect to the first holder is held by the second holder, and the second holder is further supported by the third spring balancer. In the present invention, the third spring balancer is fixed to the frame body provided above the conveyance path, and as viewed in plane, is arranged at the center in the width direction above the conveyance path. With this configuration, a burden on the first and second spring balancers can be reduced. Thus, swinging of the first holder closer to the processing tool on the cable can be reduced, and therefore, swinging of the processing tool can also be reduced. With this configuration, the accuracy of processing by the processing tool can be further improved.

(5) In the processing apparatus according to the present invention, the first and second spring balancers are, as viewed in plane, arranged substantially at the center of the processing area of the processing tool in the conveyance direction and the third spring balancer is, as viewed in plane, arranged on the upstream side of the first and second spring balancers in the conveyance direction. With this configuration, the amount of movement of the cable when the processing tool is moved to each end side of the processing area along the conveyance direction can be decreased as much as possible. Thus, swinging of the processing tool can be further reduced, and therefore, the accuracy of processing by the processing tool can be further improved.

### BRIEF DESCRIPTION OF THE DRAWINGS

FIG. 1 is a perspective view of a laser processing apparatus according to one embodiment of the present invention;

FIG. 2 is a plan view of the laser processing apparatus;

FIG. 3 is a front view of the laser processing apparatus along a conveyance direction;

FIG. 4 is a side view of the laser processing apparatus along a width direction;

FIG. 5 is a side view of a laser irradiation apparatus;

FIG. 6 is a side view of a first support unit 71 along the conveyance direction;

FIG. 7 is a view of a first outlet-side roller, a first holder-side roller, and a first roller support portion along a rotation axis of the first holder-side roller;

FIG. 8 is a front view of the laser processing apparatus along the conveyance direction; and

FIG. 9 is a side view of the laser processing apparatus along the width direction.

### DETAILED DESCRIPTION OF THE INVENTION

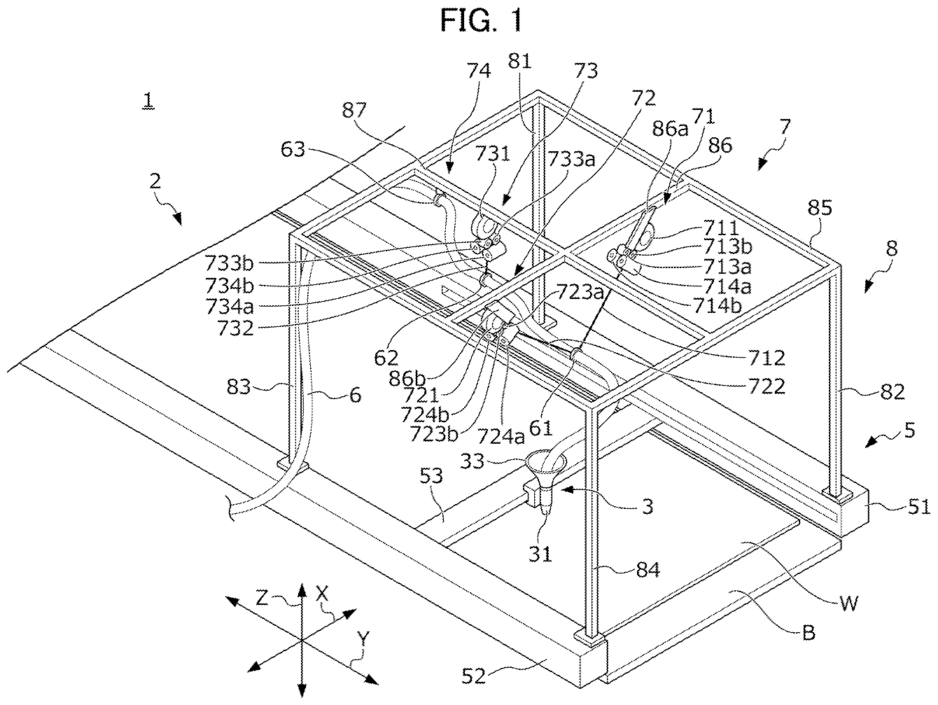

Hereinafter, a laser processing apparatus according to one embodiment of the present, invention will be described with reference to the drawings. FIG. 1 is a perspective view showing a configuration of a laser processing apparatus 1 according to the present embodiment. The laser processing apparatus 1 irradiates a workpiece W conveyed along a conveyance direction V with laser light, thereby cutting the workpiece W into a desired shape.

The laser processing apparatus 1 includes a conveyance apparatus 2 that conveys the workpiece W along the conveyance direction Y, a laser irradiation apparatus 3 that irradiates the workpiece W with laser light to cut the workpiece W, a head drive mechanism 5 that, moves the laser Irradiation apparatus 3 to a predetermined processing position above the workpiece W conveyed along the conveyance direction Y, a flexible cable 6 connecting the laser irradiation apparatus 3 and a laser oscillator (not shown) as a laser light supply source to each other, and a cable support mechanism 7 supporting the cable 6. The workpiece W is, for example, an aluminum alloy plate member or a steel plate, but the present invention is not limited to above.

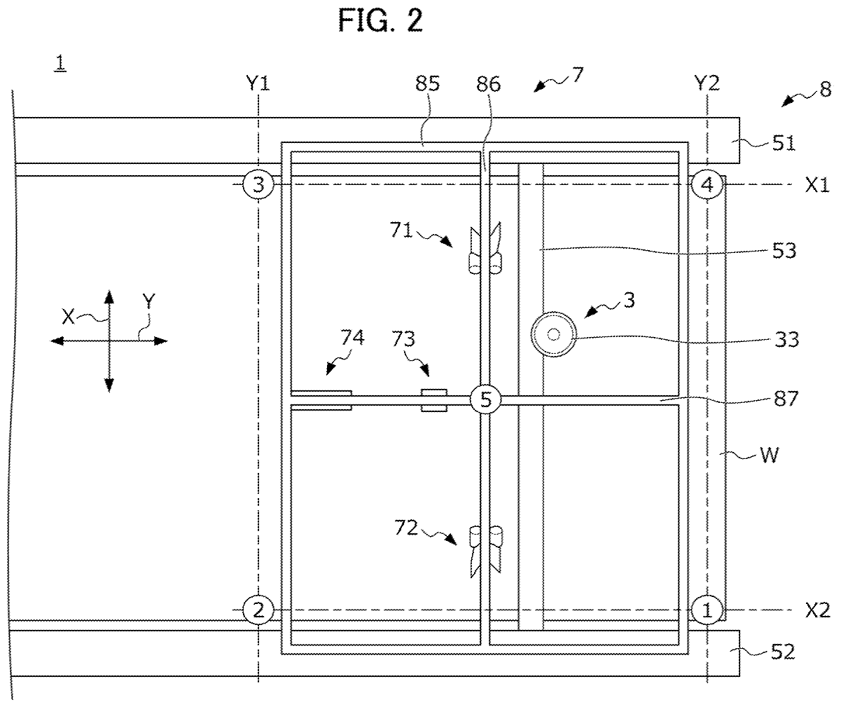

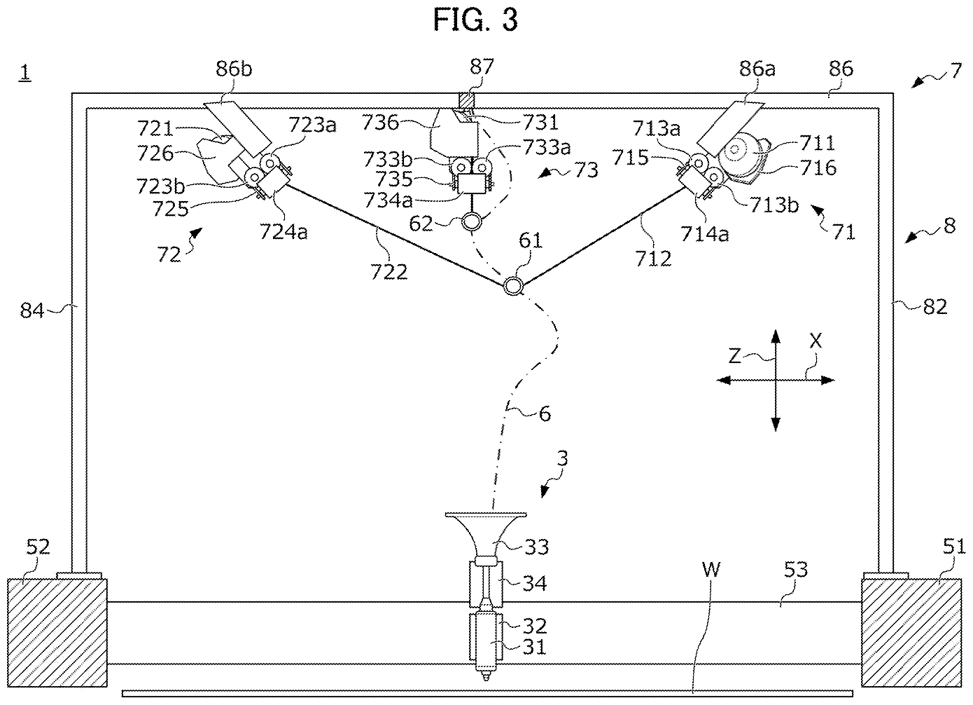

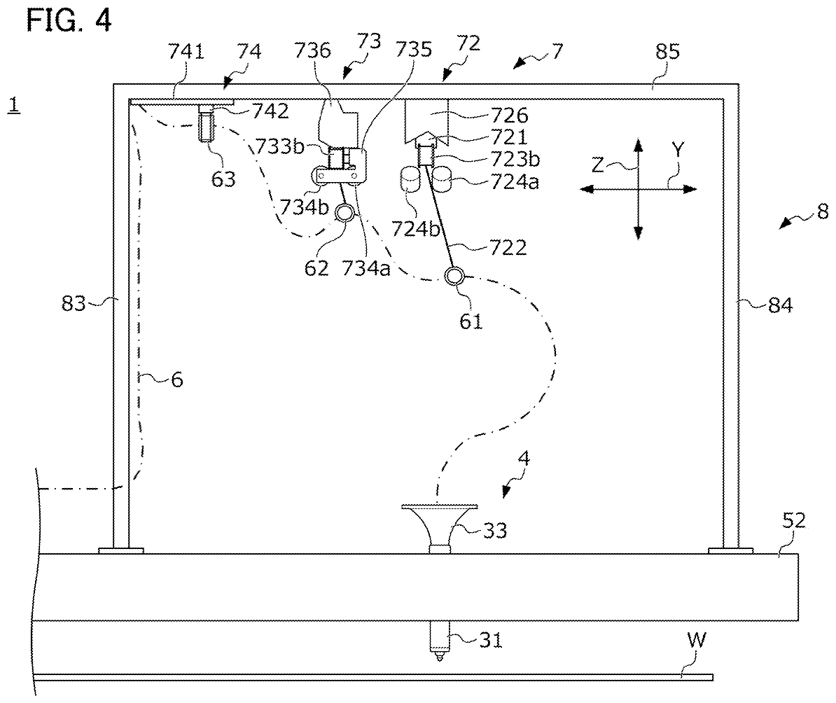

FIG. 2 is a plan view of the laser processing apparatus 1, FIG. 3 is a front view of the laser processing apparatus 1 along the conveyance direction 7, and FIG. 4 is a side view of the laser processing apparatus 1 along a width direction X perpendicular to the conveyance direction Y. Note that a direction perpendicular to the conveyance direction Y and the width direction X will hereinafter be referred to as a height direction Z. Note that for the sake of easy understanding, the cable 6 and the cable support mechanism 7 are not shown in detail in FIG. 2. Moreover, the cable 6 is indicated by a chain line in FIGS. 3 and 4.

The conveyance apparatus 2 is a belt conveyer, an includes a plurality of belt rollers (not shown) rotatable about an axis parallel with the width direction X, an endless band-shaped belt B bridged over these belt rollers, and a roller drive apparatus (not shown) that rotatably drives these belt rollers to deliver the belt B and the workpiece W placed on the belt B to a downstream side along the conveyance direction Y.

The head drive mechanism 5 includes a first Y-axis rail 51 and a second Y-axis rail 52 extending along the conveyance direction Y on both sides of the belt B and an X-axis rail 53 extending along the width direction X.

The X-axis rail 53 is, above the belt B along the height direction Z, bridged between the first Y-axis rail 51 and the second Y-axis rail 52. One end side of the X-axis rail 53 is supported by the first Y-axis rail 51, and the other end side of the X-axis rail 53 is supported by the second Y-axis rail 52. The X-axis rail 53 slidably supports the laser irradiation apparatus 3 along the width direction X. The X-axis rail 53 drives a not-shown X-axis actuator, thereby moving the laser irradiation apparatus 3 along the width direction X.

The first Y-axis rail 51 and the second Y-axis rail 52 are parallel with each other. The first Y-axis rail 51 slidably supports one end side of the X-axis rail 53 along the conveyance direction Y, and the second Y-axis rail 52 slidably supports the other end side of the X-axis rail 53 along the conveyance direction Y. These Y-axis rails 51, 52 drive a not-shown Y-axis actuator, thereby moving the X-axis rail 53 and the laser irradiation apparatus 3 together along the conveyance direction Y.

The head drive mechanism 5 uses the Y-axis rails 51, 52 and the X-axis rail 53 as described above in combination, and therefore, the laser irradiation apparatus 3 can be moved to an optional processing position set within a processing area. Note that in FIG. 2, an upstream-side processing end of the processing area along the conveyance direction Y is indicated by a line Y1, a downstream-side processing end of the processing area along the conveyance direction Y is indicated by a line Y2, a processing end of the processing area on a first Y-axis rail 51 side along the width direction X is indicated by a line X1, and a processing end of the processing area on a second Y-axis rail 52 side along the width direction X is indicated by a line X2.

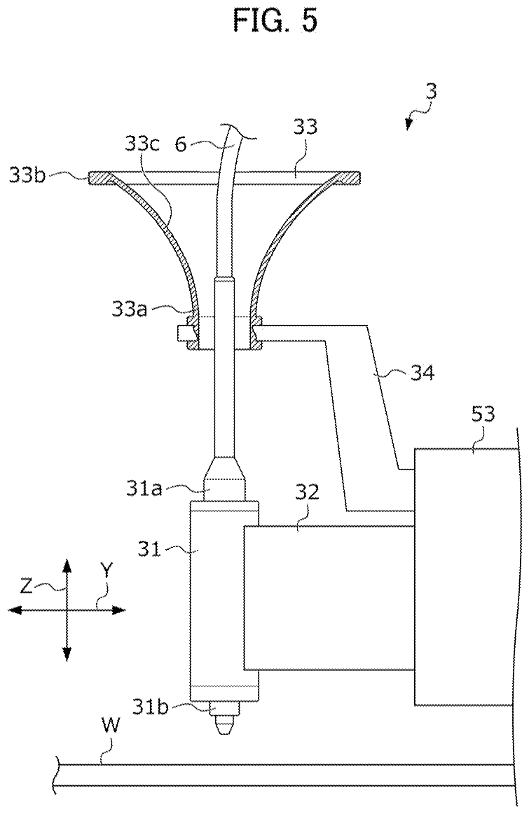

FIG. 5 is a side view of the laser irradiation apparatus 3 along the width direction X. The laser irradiation apparatus 3 includes a cylindrical laser head 31 extending along the height direction Z, a head support portion 32 supporting the laser head 31, a tubular cable guide 33 into which the cable 6 extending from a base end portion 31a of the laser head 31 is inserted, and a guide support portion 34 supporting the cable guide 33.

The laser head 31 collects laser, light transmitted from the laser oscillator through the cable 6, and along the height direction Z, irradiates the workpiece W with the laser light from a tip end portion 31b of the laser head 31. The head support portion 32 slidably supports the laser head 31 along the height direction 2. A distance from the tip end portion 31b of the laser head 31 to the workpiece W along the height direction Z is adjusted as necessary by a not-shown focusing process. Moreover, the head support portion 32 is slidably supported along the width direction X by the X-axis rail 53. The cable guide 33 is in such a conical tubular shape that the inner diameter of a tip end portion 33a is smaller than the inner diameter of a base end portion 33b. The cable 6 is inserted into the cable guide 33 such that the tip end portion 33a is substantially coaxial with the laser head 31 and is on a laser head 31 side. As shown in FIG. 5, an inner wall surface 33c of the cable guide 33 is, as viewed in the section, a curved surface with a predetermined curvature radius. Insertion of the cable 6 into such a cable guide 33 can prevent the cable 6 from bending with a smaller curvature radius than the curvature radius of the inner wall surface 33c in association with movement of the laser head 31. Thus, the curvature radius of the inner wall surface 33c is designed not to exceed an acceptable degree of bending of the cable 6.

The guide support portion 34 supports the cable guide 33. Moreover, the guide support portion 34 is slidably supported along the width direction X by both of the head support portion 32 and the X-axis rail 53 as described above. Thus, when the laser head 31 and the head support portion 32 are moved together along the X-axis rail 53, the cable guide 33 also moves along the X-axis rail 53 to follow movement of the laser head 31 and the head support portion 32. Mote that the cable guide 33 is not fixed to the cable 6 and the laser head 31. Thus, movement of the laser head 31 and the cable 6 along the height direction Z is not restricted by the cable guide 33.

Returning to description of FIGS. 1 to 4, the cable support, mechanism 7 includes a support frame 8 provided above the belt B, a first holder 61, a second holder 62, and a third holder 63 holding part of the cable 6, and a first support unit 71, a second support unit 72, a third support unit 73, and a fourth support unit 74 supporting the cable 6.

The support frame 8 includes four pillar members, i.e., a first pillar member 81, a second pillar member 82, a third pillar member 83, and a fourth pillar member 84, standing on both sides of the belt B, a frame member 85 supported by these four pillar members 81 to 84, and two beam members, i.e., a first beam member 86 and a second beam member 87, bridged over the frame member 85.

Each of the pillar members 81 to 84 extends along the height direction Z. These pillar members 81 to 84 are each provided in the vicinity of four corners of the processing area. The first pillar member 81 and the second pillar member 82 stand on the first Y-axis rail 51, and the third pillar member 83 and the fourth pillar member 84 stand on the second Y-axis rail 52. More specifically, the first pillar member 61 is provided closer to the upstream-side processing end Y1 of the processing area along the conveyance direction Y on the first Y-axis rail 51. The second pillar member 82 is provided closer to the downstream-side processing end Y2 of the processing area along the conveyance direction Y on the first Y-axis rail 51. The third pillar member 83 is provided closer to the processing end Y1 of the processing area on the second Y-axis rail 52. The fourth pillar member 84 is provided closer to the processing end Y2 of the processing area on the second Y-axis rail 52.

The frame member 85 is, as viewed in plane, in a rectangular shape surrounding the processing area. The frame member 85 is, above the belt B, supported by the four pillar members 81 to 84. Four corners of the frame member 85 are each supported by the pillar members 81 to 84.

The first beam member 86 extends along the width direction X, and the second beam member 87 extends along the conveyance direction Y. The two beam members 86, 87 are, above the belt 8, bridged perpendicularly to each other. Both ends of these beam members 86, 87 are supported by the frame member 85. The first beam member 86 is, as viewed in plane, arranged at the center of the processing area along the conveyance direction Y. The second beam member 87 is, as viewed in plane, arranged at the center of the processing area along the width direction X.

The cable 6 includes a plurality of wire members connected to the laser head 31, such as an optical cable for transmitting laser light, generated by the laser oscillator, a signal line of a sensor, a hose in which coolant water or gas flows, and a power line in which current flows.

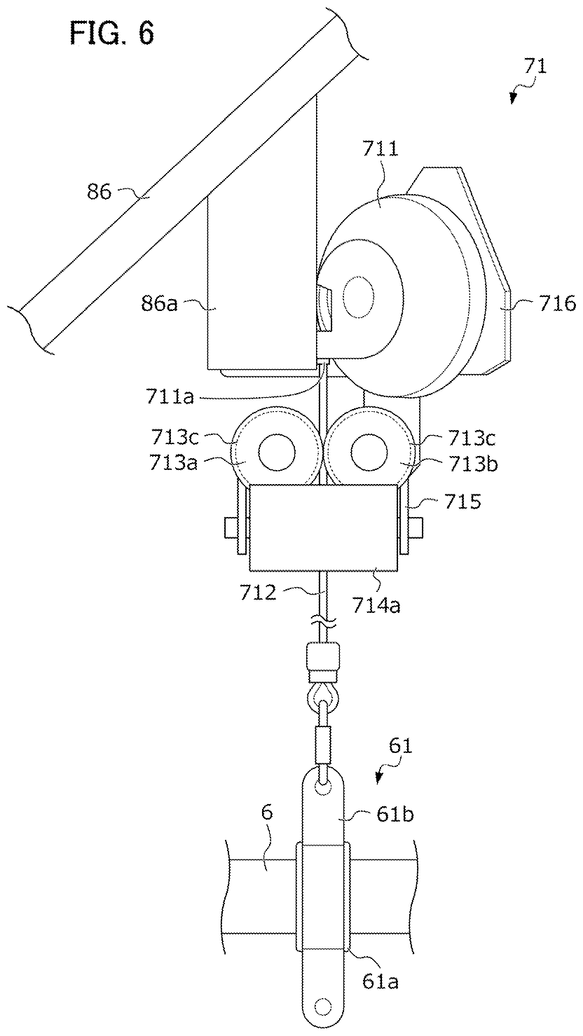

Each of the three holders 61, 62, 63 includes a cylindrical multi-packing 61a (see FIG. 6 described later) into which the above-described plurality of wire members forming the cable 6 is inserted and an annular clamp 61b (see FIG. 6 described later) sandwiching an outer peripheral surface of the multi-packing, and the cable 6 is held by the multi-packing and the clamp. The first holder 61, the second holder 62, and the third holder 63 are provided in this order from the laser head 31 side to a laser oscillator side at the cable 6 extending from the laser head 31 to the not-shown laser, oscillator. That Is, the first holder 61 holds part of the cable 6 on the laser head 31 side with respect to the second holder 62 and the third holder 63. The second holder 62 holds part of the cable 6 on the laser oscillator side with respect to the first holder 61. The third holder 63 holds part of the cable 6 on the laser oscillator side with respect to the first holder 61 and the second holder 62.

As shown in FIG. 1, the laser oscillator side of the cable 6 with respect to the third holder 63 is fixed to the pillar member 83 and the frame member 85 with the not-shown clamps to extend along the third pillar member 83 and an upstream-side portion of the frame member 35 along the conveyance direction Y.

Each of the four support units 71 to 74 is fixed to the support frame 3. Moreover, these support units 71 to 74 swingably support the cable 6, and move the cable 6 in association with movement of the laser head 31.

The first support unit 71 includes a first spring balancer 711 connected to the first holder 61 through a first wire 712. The first spring balancer 711 includes a rotary drum around which the first wire 712 is wound and a spring providing torque for winding up the first wire 712 to the rotary drum, and with this configuration, the first wire 712 and the first holder 61 connected to a tip end of the first wire 712 are drawn up with a predetermined load. The first support unit 71 utilizes such a first spring balancer 711, and therefore, part of the cable 6 held by the first holder 61 is swingably supported.

The second support unit 72 includes a second spring balancer 721 connected to the first holder 61 through a second wire 722. The second spring balancer 721 includes a rotary drum around which the second wire 722 is wound and a spring providing torque for winding up the second wire 722 to the rotary drum, and with this configuration, the second wire 722 and the first holder 61 connected to a tip end of the second wire 722 are drawn up with a predetermined load. The second support unit 72 utilizes such a second spring balancer 721, and therefore, part of the cable 6 held by the first holder 61 is swingably supported. That is, the first holder 61 provided at a position closest: to the laser head 31 on the cable 6 is, above the belt B, supported by the two spring balancers 711, 721.

The third support unit 73 includes a third spring balancer 731 connected to the second holder 62 through a third wire 732. The third spring balancer 731 includes a rotary drum around which the third wire 732 is wound and a spring providing torque for winding up the third wire 732 to the rotary drum, and with this configuration, the third wire 732 and the second holder 62 connected to a tip end of the third wire 732 are drawn up with a predetermined load. The third support unit 73 utilizes such a third spring balancer 731, and therefore, part of the cable 6 held by the second holder 62 is swingably supported. That is, the second holder 62 provided at a position farther from the laser head 31 than the first holder 61 on the cable 6 is, above the belt B, supported by the single spring balancer 731.

The fourth support unit 74 includes a center rail 741 provided at the second beam member 87 and a support member 742 supporting the third holder 63. The center rail 741 extends along the conveyance direction Y. The center rail 741 is provided closer to the frame member 85 on the second beam member 87. That is, the center rail 741 is, as viewed in plane, arranged at the center along the width direction X on the upstream side of the processing area along the conveyance direction Y. The support, member 742 is, for example, a swivel. The upstream side of the support member 742 is slidably provided along the center rail 74l, and the downstream side of the support member 742 is coupled to the third holder 63. Thus, the third holder 63 is, above the belt B, slidable along the conveyance direction Y. With this configuration, the fourth support unit 74 slidably supports, above the belt B, the third holder 63 along the conveyance direction Y, the third holder 63 being provided at a position farther from the laser head 31 than the first holder 61 and the second holder 62 on the cable 6. In the case of using the swivel as the support member 742, an axial direction of part of the cable 6 held by the third holder 63 can also be turned about an axis along the height direction Z.

FIG. 6 is a side view of the first support unit 71 along the conveyance direction Y. The first support unit 71 includes the discoid first spring balancer 711, a pair of first outlet-side rollers 713a, 713b provided to sandwich the first wire 712 drawn out of a first wire outlet 711a of the first spring balancer 711, a pair of first holder-side rollers 714a, 714b provided to sandwich the first wire 712, a first roller support portion 7 is rotatably supporting the first outlet-side rollers 713a, 713b and the first holder-side rollers 714a, 714b, and a first; bracket 716 supporting the first spring balancer 711 and the first roller support portion 715.

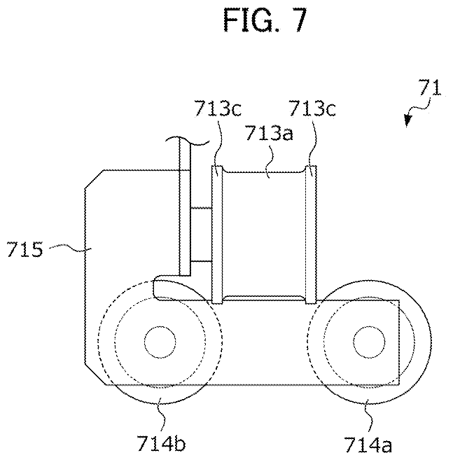

FIG. 7 is a view of the first; outlet-side rollers 713a, 713b, the first holder-side rollers 714a, 714b, and the first roller support portion 715 along a rotation axis of the first holder-side rollers 714a, 714b.

One end side of the first wire 712 is wound up around the first, spring balancer 711, and the other end side is connected to the first holder 61 as described above. The first outlet-side rollers 713a, 713b sandwich part of the first wire 712, which extends from the first wire outlet 711a to the first holder 61, in the vicinity of the first wire outlet 711a. The first holder-side rollers 714a, 714b sandwich part of the first wire 712 on a first holder 61 side with respect to the first outlet-side rollers 713a, 713b. That is, a distance from the first holder-side rollers 714a, 714b to the first wire outlet 711a along the first wire 712 is longer than a distance from the first outlet-side rollers 713a, 713b to the first wire outlet 711a along the first wire 712.

The first outlet-side rollers 713a, 713b are freely rotatable about a rotation axis parallel with the conveyance direction Y. The first holder-side rollers 714a, 714b are freely rotatable about an axis perpendicular to the rotation axis of the first outlet-side rollers 713a, 713b in a plane including the width direction X.

An outer peripheral surface of the first outlet-side roller 713a, 713b is in a recessed shape as viewed in the section (see FIG. 7). Thus, movement of the first wire 712 along the rotation axis of these first outlet-side rollers 713a, 713b is restricted by annular edge portions 713c provided on both end sides of the outer peripheral surface of the first outlet-side roller 713a, 713b along the rotation axis. On the other hand, an outer peripheral, surface of the first: holder-side roller 714a, 714b is substantially flat. The size of the outer peripheral surface of the first holder-side roller 714a, 714b is longer, than the size of the outer peripheral surface of the first outlet-side roller 713a, 713b. The first bracket 716 supports the first spring balancer 711, the first outlet-side rollers 713a, 713b, and the first holder-side rollers 714a, 714b in this order in a line. Moreover, the first bracket 716 is fixed to a first support plate 86a provided inclined with respect to the first beam member 86.

As shown in FIGS. 1 to 4, the second support unit 72 includes the second spring balancer 721, the second wire 722, a pair of second outlet-side rollers 723a, 723b, a pair of second holder-side rollers 724a, 724b, a second roller support portion 725, and a second bracket 726. The second bracket 726 is fixed to a second support plate 86b provided inclined with respect to the first beam member 86. Note that the second spring balancer 721, the second wire 722, the second outlet-side rollers 723a, 723b, the second holder-side rollers 724a, 724b, the second roller support portion 725, and the second bracket 726 have substantially the same configurations as those of the first spring balancer 711, the first wire 712, the first outlet-side rollers 713a, 713b, the first holder-side rollers 714a, 714b, the first roller support portion 715, and the first bracket 716 of the first support unit 71, and therefore, detailed description will be omitted.

As shown in FIGS. 1 to 4, the third support unit 73 includes the third spring balancer 731, the third wire 732, a pair of third outlet-side rollers 733a, 733b, a pair of third holder-side rollers 734a, 734b, a third roller support portion 735, and a third bracket 736. The third spring balancer 731 is fixed to the second beam member 87 with a not-shown hook. Note that the third spring balancer 731, the third wire 732, the third outlet-side rollers 733a, 733b, the third holder-side rollers 734a, 734b, the third roller support portion 735, and the third bracket 736 have substantially the same configurations as those of the first spring balancer 711, the first wire 712, the first outlet-side rollers 713a, 713b, the first holder-side rollers 714a, 714b, the first roller support portion 715, and the first bracket 716 of the first support unit 71, and therefore, detailed description will be omitted.

Next, positions at which these three support units 71 to 73 are provided will be described. As shown in FIGS. 1 to 4, the first spring balancer 711 and the second spring balancer 721 are fixed in a line along the first beam member 86. More specifically, the first spring balancer 711 is fixed at a position away from the second beam member 87 towards the first Y-axis rail 51 side by a predetermined space on the first beam member 86. The second spring balancer 721 is fixed to a position away from the second beam member 87 towards the second Y-axis rail 52 side by a predetermined space on the first beam member 86. A distance from the second beam member 87 along the width direction X is substantially equal between the first spring balancer 711 and the second spring balancer 721. As described above, the first spring balancer 711 and the second spring balancer 721 are arranged in a line along the width direction X at the center of the processing area of the laser, head 31 along the conveyance direction Y as viewed in plane.

As shown in FIGS. 1 to 4, the first spring balancer 711 is, as viewed along the conveyance direction Y, fixed and inclined with respect to the first beam member 86 on the first Y-axis rail 51 side with respect to the center of the processing area of the laser head 31 along the width direction X such that the first holder-side rollers 714a, 714b are closer to the center along the width direction X than the first wire outlet of the first spring balancer 711. The second spring balancer 721 is, as viewed along the conveyance direction Y, fixed and inclined with respect to the first beam member 86 on the second Y-axis rail 52 side with respect to the center of the processing area of the laser head 31 along the width direction X such that the second holder-side rollers 724a, 724b are closer to the center along the width direction X than a second wire outlet of the second spring balancer 721. Thus, in a case where no external force (e.g., tension acting on the cable 6 due to movement of the laser head 31) other than the force of gravity acting on the cable 6, the first holder 61 supported by the two spring balancers 711, 721 is, above the belt B, arranged substantially at the center along the width direction X.

As shown in FIGS. 1 to 4, the third spring balancer 731 is fixed to the second beam member 87. More specifically, the third spring balancer 731 is fixed to the upstream side of the second beam member 87 with respect to the first beam member 86 and the downstream side of the fourth support unit 74 with respect to the center rail 741. As described above, the third spring balancer 731 is, above the belt B as viewed in the plane, arranged at the center of the processing area of the laser head 31 along the width direction X on the upstream side of the first spring balancer 711 and the second spring balancer 721 along the conveyance direction Y.

Note that unlike the first spring balancer 711 and the second spring balancer 721 as described above, the third spring balancer 731 is not fixed and inclined with respect to the second beam member 87. That is, the third spring balancer 731 is fixed to the second beam member 87 such that a third wire outlet, the third outlet-side rollers 733a, 733b, and the third holder-side rollers 734a, 734b are arranged in a line along the height direction Z.

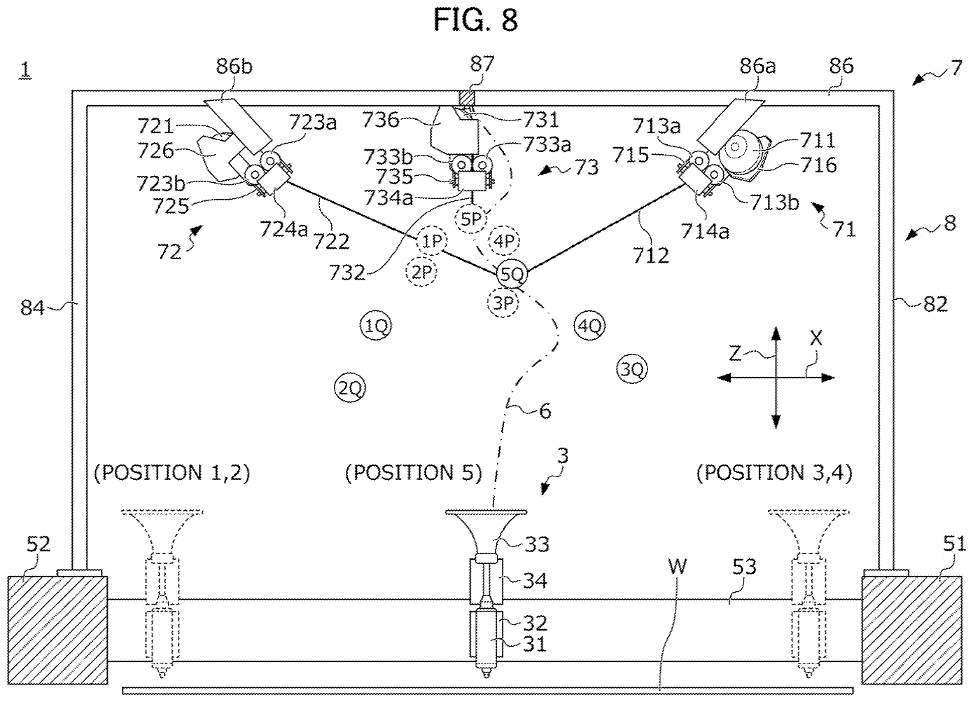

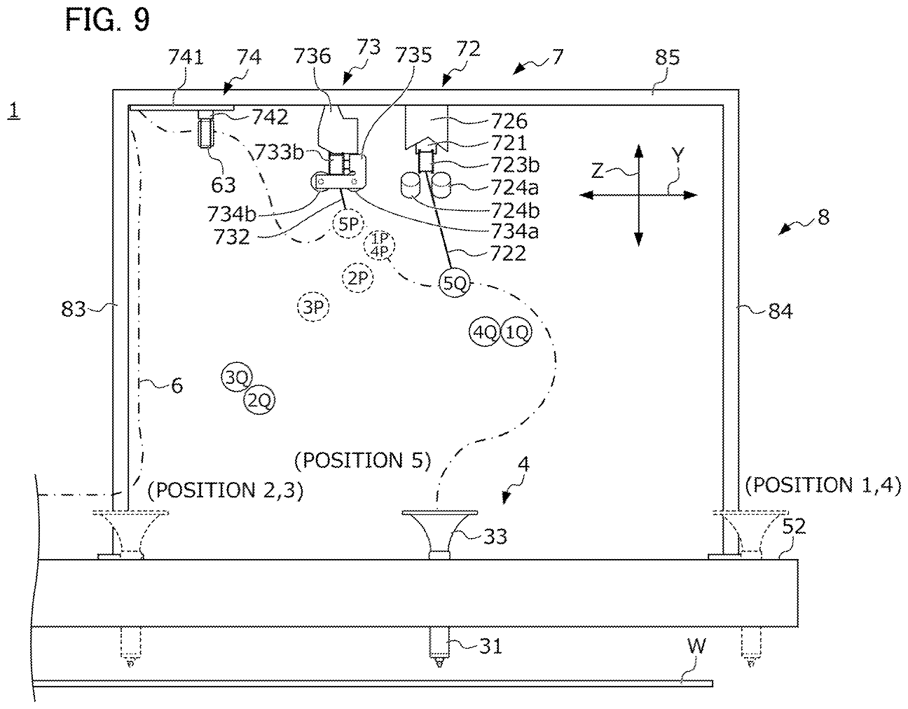

Next, a change in the positions of the first holder 61 and the second holder 62 when the laser head 31 is moved within the processing area will be described with reference to FIGS. 8 and 9.

FIG. 8 is a front view of the laser processing apparatus 1 along the conveyance direction Y, and FIG. 9 is a side view of the laser processing apparatus 1 along the width direction X. FIGS. 8 and 9 indicate the positions of the first holder 61 and the second holder 62 when the laser head 31 is moved to positions 1 to 5 shown in FIG. 2 by a solid circle and a dashed circle.

As shown in FIG. 2, the position 1 is set to an intersection between the processing ends Y2, X2, the position 2 is set to an intersection between the processing ends Y1, X2, the position 3 is set to an intersection between the processing ends Y1, X1, and the position 4 is set to an intersection between the processing ends Y2, X1. The position 5 is set to an intersection between the first beam member 86 and the second beam member 87, i.e., the center of the processing area. FIGS. 8 and 9 indicate the positions of the first holder 61 and the second holder 62 when the laser head 31 is moved to the position 1 by 1Q and 1P, indicate the positions of the first holder 61 and the second holder 62 when the laser head 31 is moved to the position 2 by 2Q and 2P, indicate the positions of the first holder 61 and the second holder 62 when the laser head 31 is moved to the position 3 by 3Q and 3P, indicate the positions of the first holder 61 and the second holder 62 when the laser head 31 is moved to the position 4 by 4Q and 4P, and indicate the positions of the first holder 61 and the second holder 62 when the laser head 31 is moved to the position 5 by 5Q end 5P.

As shown in FIG. 3, as viewed along the conveyance direction Y in the laser processing apparatus 1, the first spring balancer 711 and the second spring balancer 721 are fixed and inclined with respect to the first beam member 86. Thus, the drawing angles of the wires 712, 722 of the first and second spring balancers 711, 721 when the laser head 31 is moved along the width direction X can be decreased as much as possible, and therefore, swinging of the cable 6 and the laser-head 31 can be further reduced.

As shown in FIG. 9, in the laser processing apparatus 1, the first spring balancer 711 and the second spring balancer 721 are, as viewed in plane, arranged substantially at the center of the processing area of the laser head 31 along the conveyance direction Y, and the third spring balancer 731 is, as viewed in plane, arranged on the upstream side of the first and second spring balancers 711, 721 along the conveyance direction Y. With this configuration, the amount of movement of the cable 6 when the laser head 31 is moved to each end side of the processing area along the conveyance direction Y can be decreased as much as possible. Thus, swinging of the laser, head 31 can be further reduced, and therefore, the accuracy of processing by the laser head 31 can be further improved.

According to the laser processsing apparatus 1 of the present embodiment, the following advantageous effects are provided.

(1) In the laser processing apparatus 1, part of the cable 6 connecting the laser head 31 and, e.g., the laser oscillator to each other is held by the first holder 61, and the first holder 61 is supported by the first spring balancer 711 and the second spring balancer 721. With this configuration, a load on the head drive mechanism 5 when the laser head 31 is moved by the head drive mechanism 5 can be reduced. In the laser processing apparatus 1, these two spring balancer's 711, 721 are fixed to the first beam member 86 provided above the belt B, and therefore, movement of the two spring balancers 711, 721 in association with movement of the laser head 31 can be prevented. Movement of the two spring balancers 711, 721 is prevented as described above, and therefore, swinging of the cable 6 and the laser head 31 due to movement of the laser head 31 can be reduced. Thus, the accuracy of processing by the laser head 31 can be improved. In the laser processing apparatus 1, these spring balancers 711, 721 are, as viewed in plane, arranged in a line along the width direction X perpendicular to the conveyance direction Y. With this configuration, the amount of movement of the cable 6 and the amounts of expansion/contraction of the wires 712, 722 of the two spring balancers 711, 721 when the laser head 31 is moved along the conveyance direction Y and the width direction X can be decreased. Thus, swinging of the laser head 31 can be further reduced, and therefore, the accuracy of processing by the laser head 31 can be further improved.

(2) In the laser processing apparatus 1, the first wire 712 drawn out; of the first wire outlet 711a of the first; spring balancer 711 is sandwiched by the first outlet-side rollers 713a, 713b and the first holder-side rollers 714a, 714b, and the second wire 722 drawn out of the second wire outlet of the second spring balancer 721 is sandwiched by the second outlet-side rollers 723a, 723b and the second holder-side rollers 724a, 724b. In the laser processing apparatus 1, the outer peripheral surfaces of these outlet-side rollers 713a, 713b, 723a, 723b are in the recessed shape as viewed in the section, and the size of the outer peripheral surface of the holder-side roller 714a, 714b, 724a, 724b is longer than the size of the outer peripheral surface of the outlet-side roller 713a, 713b, 723a, 723b. In the laser processing apparatus 1, the wires 712, 722 drawn out of each wire outlet by the outlet-side rollers 713a, 713b, 723a, 723b and the holder-side rollers 714a, 714b, 724a, 724b are supported while being rolled. Thus, the wires 712, 722 can be bent such that the cable 6 moves to a proper position with respect to the laser head 31 moving along the conveyance direction Y and the width direction X while friction in each wire outlet is reduced.

(3) As viewed along the conveyance direction Y in the laser processing apparatus 1, on one side with respect to the center of the processing area of the laser head 31 in the width direction, the first holder-side rollers 714a, 714b are fixed and inclined with respect to the first beam member 66 to be closer to the center in the width direction than the first wire outlet 711a of the first spring balancer 711. On the other side with respect to the center of the processing area in the width direction, the second holder-side rollers 724a, 724b are fixed and inclined with respect to the support frame 8 to be closer to the center in the width direction than the second wire outlet of the second spring balancer 721. With this configuration, the drawing angles of the wires 712, 722 of the first and second spring balancers 711, 721 when the laser head 31 is moved along the conveyance direction Y and the width direction X can be decreased as much as possible, and therefore, swinging of the cable 6 and the laser head 31 can be further reduced.

(4) In the laser processing apparatus 1, the laser oscillator side of the cable 6 with respect to the first holder 61 is held by the second holder 62, and the second holder 62 is further supported by the third spring balancer 731. In the laser processing apparatus 1, the third spring balancer 731 is fixed to the second beam member 87, and as viewed in plane, is arranged at the center in the width direction above the belt B. With this configuration, a burden on the first and second spring balancers 711, 721 can be reduced. Thus, swinging of the first holder 61 closer to the laser head 31 on the cable 6 can be reduced, and therefore, swinging of the laser head 31 can be also reduced. With this configuration, the accuracy of processing by the laser head 31 can be further improved.

(5) In the laser processing apparatus 1, the first and second spring balancers 711, 721 are, as viewed in plane, arranged substantially at the center of the processing area of the laser head 31 in the conveyance direction, and the third spring balancer 731 is, as viewed in plane, arranged on the upstream side of the first and second spring balancers 711, 721 in the conveyance direction. With this configuration, the amount of movement of the cable 6 when the laser head 31 is moved to each end side of the processing area along the conveyance direction V can be decreased as much as possible. Thus, swinging of the laser head 31 can be further reduced, and therefore, the accuracy of processing by the laser head 31 can be further improved.

One embodiment of the present invention has been described above, but the present invention is not limited to above. Detailed configurations may be changed as necessary within the scope of the gist of the present invention.

What is claimed is:

1. A processing apparatus comprising:
a processing tool that processes a workpiece;
a flexible cable connecting a supply source and the processing tool to each other;
a conveyance apparatus that conveys the workpiece along a conveyance direction on a conveyance path;
a tool movement mechanism that moves the processing tool to a processing position; and
a cable support mechanism that supports the cable and moves the cable in association with movement of the processing tool,
wherein the cable support mechanism includes a first, holder holding part of the cable, a first spring balancer connected to the first holder through a first wire, and a second spring balancer connected to the first holder through a second wire, and
the first and second spring balancers are fixed above the conveyance path, and as viewed in plane, are arranged along a width direction perpendicular to the conveyance direction.

2. The processing apparatus according to claim 1, wherein the cable support mechanism includes a pair of first outlet-side rollers provided to sandwich the first wire, a pair of first holder-side rollers provided to sandwich a first holder side of the first wire with respect to the first outlet-side rollers and provided rotatably about an axis perpendicular to a rotation axis of the first outlet-side rollers, a pair of second outlet-side rollers provided to sandwich the second wire, and a pair of second holder-side rollers provided to sandwich a first holder side of the second wire with respect to the second outlet-side rollers and provided rotatable about an axis perpendicular to a rotation axis of the second outlet-side rollers,
outer peripheral surfaces of the first and second outlet-side rollers are in a recessed shape as viewed in section, and
a size of each outer peripheral surface of the pairs of first and second holder-side rollers is longer than a size of each outer peripheral surface of the pairs of first and second outlet-side rollers.

3. The processing apparatus according to claim 2, wherein on one side with respect to a center of a processing area of the processing tool in the width direction as viewed along the conveyance direction, the first spring balancer is fixed and inclined such that the first holder-side rollers are closer to the center in the width direction than a first wire outlet of the first spring balancer, and
on the other side with respect to the center of the processing area in the width direction as viewed along the conveyance direction, the second spring balancer is fixed and inclined such that the second holder-side rollers are closer to the center in the width direction than a second wire outlet of the second spring balancer.

4. The processing apparatus according to claim 1, wherein the cable support mechanism Includes a second holder holding a supply source side of the cable with respect to the first holder and a third spring balancer connected to the second holder through a third wire, and
the third spring balancer is fixed to a frame body provided above the conveyance path, and as viewed in plane, is arranged substantially at a center in the width direction above the conveyance path.

5. The processing apparatus according to claim 2, wherein the cable support mechanism includes a second holder holding a supply source side of the cable with respect to the first holder and a third spring balancer connected to the second holder through a third wire, and
the third spring balancer is fixed to a frame body provided above the conveyance path, and as viewed in plane, is arranged substantially at a center in the width direction above the conveyance path.

6. The processing apparatus according to claim 3, wherein the cable support mechanism includes a second holder holding a supply source side of the cable with respect to the first holder and a third spring balancer connected to the second holder through a third wire, and
the third spring balancer is fixed to a frame body provided above the conveyance path, and as viewed in plane, is arranged substantially at a center in the width direction above the conveyance path.

7. The processing apparatus according to claim 4, wherein the first and second spring balancers are, as viewed in plane, arranged at a center of a processing area of the processing tool in the conveyance direction, and
the third spring balancer is, as viewed in plane, arranged on an upstream side of the first and second spring balancers in the conveyance direction.

8. The processing apparatus according to claim 5, wherein the first and second spring balancers are, as viewed in plane, arranged at a center of a processing area of the processing tool in the conveyance direction, and
the third spring balancer is, as viewed in plane, arranged on an upstream side of the first and second spring balancers in the conveyance direction.

9. The processing apparatus according to claim 6, wherein the first and second spring balancers are, as viewed in plane, arranged at the center of the processing area of the processing tool in the conveyance direction, and
the third spring balancer is, as viewed in plane, arranged on an upstream side of the first and second spring balancers in the conveyance direction.
